(19) United States
(12) Patent Application Publication
(10) Pub. No.: US 2011/0193442 A1
(43) Pub. Date: Aug. 11, 2011

(54) INSULATED WIRE, ELECTRICAL COIL USING THE INSULATED WIRE, AND MOTOR

(76) Inventors: Kengo Yoshida, Kouka-shi (JP); Katsufumi Matsui, Kouka-shi (JP); Masahiro Koyano, Kouka-shi (JP)

(21) Appl. No.: 12/681,258

(22) PCT Filed: Oct. 9, 2008
(86) PCT No.: PCT/JP2008/068371

§ 371 Date: Apr. 1, 2010

(30) Foreign Application Priority Data
Oct. 12, 2007 (JP) 2007-266405

(51) Int. Cl. H02K 3/00; H01B 3/30

(52) U.S. Cl. 310/179; 174/110 SR

(57) ABSTRACT

There is disclosed an insulated wire comprising a conductor, a primer layer coating the conductor, and an insulating layer coating the primer layer. The primer layer is formed by curing an epoxy resin.

### RELATED APPLICATIONS

This application is the U.S. National Phase under 35 U.S.C. §371 of International Application No. PCT/JP2008/068371, filed on Oct. 9, 2008, which in turn claims the benefit of Japanese Application No. 2007-266405, filed on Oct. 12, 2007, the disclosures of which Applications are incorporated by reference herein.

### FIELD OF THE INVENTION

The present invention relates to an insulated wire, particularly to an insulated wire excellent in adhesion between a conductor and an insulating layer not only at ordinary temperatures, but also in the case where the insulated wire is heated. The present invention also relates to an electrical coil using the insulated wire and a motor.

### BACKGROUND OF THE INVENTION

Generally, an insulated wire is composed of a conductor and an insulating layer coating the conductor. The insulating layer is required to have high mechanical strength in order to avoid layer defects and poor grounding which are generated as a result of having suffered damage. The insulating layer is also required to have heat resistance in order to prevent the insulating layer from being softened or deteriorating due to the generation of heat by a large current.

For these reasons, a polyimide resin such as polyesterimide having high mechanical strength and heat resistance is widely used for the insulating layer. However, the adhesion between a polyimide resin and a conductor is not sufficient. For this reason, a polyimide insulating coating to which melamine is added to improve the adhesion is proposed, for example, in Patent Document 1. Further, Patent Document 2 proposes an insulating coating which contains a metal deactivator such as an acetylene and a curable resin such as a phenol resin in order to improve the adhesion.

However, when the insulating coatings disclosed in the above documents are heated, for example, in treatment with an impregnating varnish or the like, the adhesion between a coating film comprising an insulating material and a conductor may be reduced.
Patent Document 1: Japanese Laid-Open Patent Publication No. 10-334735
Patent Document 2: Japanese Patent No. 3766447

### SUMMARY OF THE INVENTION

An objective of the present invention is to provide an insulated wire excellent in adhesion between a conductor and an insulating layer not only at ordinary temperatures, but also in the case where the insulated wire is heated, for example, in treatment with an impregnating varnish or the like, and to provide an electrical coil using the insulated wire and a motor.

In order to solve the above problems, a first aspect of the present invention provides an insulated wire comprising a conductor, a primer layer coating the conductor, and an insulating layer coating the primer layer. The primer layer is formed by curing an epoxy resin. The insulated wire having the above constitution is excellent in adhesion between the conductor and the insulating layer not only at ordinary temperatures, but also in the case where the insulated wire is heated, for example, in treatment with an impregnating varnish or the like.

In the above insulated wire, the primer layer comprises a resin composition comprising an epoxy resin and a curing agent, wherein the content of the curing agent is preferably from 5 to 30 parts by weight with respect to 100 parts by weight of the epoxy resin. In this case, the insulated wire is excellent not only in adhesion between the conductor and the insulating layer, but also in heat resistance.

In the above insulated wire, the primer layer is preferably formed by applying the resin composition to the conductor and baking the resin composition. In this case, the insulated wire is more excellent in adhesion between the conductor and the insulating layer.

In the above insulated wire, the curing agent is preferably a melamine compound. In this case, the insulated wire is excellent not only in adhesion between the conductor and the insulating layer, but also in heat resistance.

In the above insulated wire, the curing agent is preferably an isocyanate. In this case, the insulated wire is excellent not only in adhesion between the conductor and the insulating layer, but also in heat resistance even when the insulated wire is heated for a long period of time.

In the above insulated wire, the insulating layer preferably comprises, as a main component, at least one resin selected from the group consisting of polyesterimide, polyamideimide, polyester, and polyimide. In this case, the insulated wire is excellent not only in adhesion between the conductor and the insulating layer, but also in heat resistance.

In order to solve the above problems, a second aspect of the present invention provides an electrical coil prepared by winding the insulated wire. In this case, it is possible to provide an electrical coil which is excellent not only in adhesion between the conductor and the insulating layer, but also in heat resistance.

In order to solve the above problems, a third aspect of the present invention provides a motor comprising the electrical coil. In this case, it is possible to provide a motor which is excellent not only in adhesion between the conductor and the insulating layer, but also in heat resistance.

### DETAILED DESCRIPTION OF THE PREFERRED EMBODIMENTS

The insulated wire of the present invention comprises a conductor, a primer layer coating the conductor, and an insulating layer coating the primer layer. The primer layer is a layer formed by curing an epoxy resin. The insulated wire of the present invention is excellent in adhesion between the conductor and the insulating layer not only at ordinary temperatures, but also in the case where the insulated wire is heated. The reason will be described below.

A conventional insulated wire comprises an insulating layer formed by applying, to a conductor, an insulating coating obtained by adding melamine to a polyimide resin. In this type of insulated wires, it is estimated that the adhesion between the conductor and the insulating layer is prevented by the seepage of melamine from the insulating layer when the insulated wire is heated.

In contrast, the primer layer formed on the conductor of the insulated wire of the present invention comprises, for example, a cured product of an epoxy resin obtained by allowing the epoxy resin and a curing agent to react with each other to chemically stably bond the both. This suppresses the seepage of the curing agent from the primer layer, thereby increasing adhesion between the conductor and the primer layer, and adhesion between the primer layer and the insulating layer. Further, the primer layer of the insulated wire of the present invention has excellent adhesion to both a metal conductor and an insulating layer composed of polyesterimide, polyamideimide, polyester, polyimide, or the like. For this reason, the conductor and the insulating layer can be strongly adhered through the primer layer.

Thus, in the insulated wire of the present invention, melamine or the like does not seep from the insulating layer upon heating, unlike conventional insulated wires. As a result, the insulated wire of the present invention is excellent in adhesion between the conductor and the insulating layer not only at ordinary temperatures, but also in the case where the insulated wire is heated. Therefore, the insulated wire of the present invention can be suitably used in the field in which a coil comprising an insulated wire requires heat treatment, such as treatment with an impregnating varnish, in the field of producing self-bonding wires, and the like.

The primer layer is a layer formed by curing an epoxy resin. The primer layer may contain an uncured epoxy resin as long as it is within the range from which the objective of the present invention is not prevented.

The primer layer comprises a resin compound comprising an epoxy resin and a curing agent. In this case, the content of the curing agent is 5 to 30 parts by weight with respect to 100 parts by weight of the epoxy resin.

Examples of the epoxy resin include an epoxy resin produced from bisphenol and epihalohydrin and an epoxy resin obtained by subjecting a phenol epoxy resin and bisphenol to addition polymerization reaction. These may be used independently or in combination of two or more. Among them, the epoxy resin produced from bisphenol and epihalohydrin is preferred, and a phenoxy resin having a relatively large molecular weight is more preferred.

Examples of the bisphenol include 2,2-bis(4-hydroxyphenyl)methane, 2,2-bis(4-hydroxyphenyl)propane, 2,2-bis(4-hydroxyphenyl)sulfide, 2,2-bis(4-hydroxyphenyl)sulfone, and 3,4,5,6-dibenzo-1,2-oxaphosphane-2-oxide-hydroquinone. These may be used independently or in combination of two or more. Epichlorohydrin is mentioned as a suitable representative example of epihalohydrin.

Examples of the suitable epoxy resin produced from bisphenol and epihalohydrin include a bisphenol A-modified phenoxy resin produced from bisphenol A and epihalohydrin, and a bisphenol S-modified phenoxy resin produced from bisphenol S and epihalohydrin. All of these phenoxy resins are commercially available compounds, and the representative examples thereof include those having a product number of YP-50, YP-50S, YP-55, YP-70, and YPS007A30A, manufactured by Tohto Kasei Co., Ltd. The present invention is not limited to these examples.

The weight average molecular weight of epoxy resin is not particularly limited, but it is preferably from 30,000 to 100,000, more preferably from 50,000 to 80,000, from the viewpoint of increasing heat resistance and adhesion.

Examples of the curing agent include a melamine compound and isocyanate. These may be used independently or in combination.

When a melamine compound is used as a curing agent, it is possible to form a primer layer excellent in adhesion between the conductor and the insulating layer and heat resistance.

Examples of the melamine compound include methylated melamine, butylated melamine, methylolated melamine, and butylolated melamine. These may be used independently or in combination of two or more.

When isocyanate is used as a curing agent, it is possible to form a primer layer excellent in adhesion between the conductor and the insulating layer and heat resistance, and also excellent in adhesion even after heating for a long time. Among the isocyanate, a blocked isocyanate is preferred from the viewpoint of the storage stability of a resin composition.

Examples of the isocyanate include aromatic diisocyanates such as tolylene diisocyanate (TDI), diphenylmethane diisocyanate (MDI), p-phenylene diisocyanate, and naphthalene diisocyanate; aliphatic diisocyanates having 3 to 12 carbon atoms such as hexamethylene diisocyanate (HDI), 2,2,4-trimethylhexane diisocyanate, and lysine diisocyanate; cycloaliphatic diisocyanates having 5 to 18 carbon atoms such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidenedicyclohexyl-4,4′-diisocyanate, 1,3-diisocyanatomethylcyclohexane (hydrogenated XDI), hydrogenated TDI, 2,5-bis(isocyanatomethyl)-bicyclo[2.2.1] heptane, and 2,6-bis(isocyanatomethyl)-bicyclo[2.2.1]heptane; aliphatic diisocyanates having an aromatic ring such as xylylene diisocyanate (XDI) and tetramethylxylylene diisocyanate (TMXDI); and modified products of these diisocyanates. These may be used independently or in combination of two or more.

A blocked isocyanate is an isocyanate protected by a blocking agent. A preferred blocking agent is added to an isocyanate group and is stable at ordinary temperatures, but regenerates a free isocyanate group when it is heated to a dissociation temperature thereof or higher. The dissociation temperature of a blocked isocyanate is preferably from 80 to 160° C., more preferably from 90 to 130° C.

Examples of the blocking agent include alcohols, phenols, ε-caprolactam, and butyl cellosolve, but the present invention is not limited to these examples. Examples of the alcohols include methanol, ethanol, propanol, butanol, benzyl alcohol, and cyclohexanol. Examples of the phenols include phenol, cresol, and xylenol. Among these, alcohols are preferred.

The content of the curing agent is preferably 3 parts by weight or more, more preferably 5 parts by weight or more, further preferably 10 parts by weight or more with respect to 100 parts by weight of epoxy resin from the viewpoint of increasing the adhesion between the conductor and the insulating layer, and particularly preferably 30 parts by weight or more with respect to 100 parts by weight of epoxy resin from the viewpoint of increasing refrigerant resistance. Further, the amount of the curing agent is preferably 60 parts by weight or less, more preferably 50 parts by weight or less, further preferably 40 parts by weight or less with respect to 100 parts by weight of epoxy resin from the viewpoint of increasing heat resistance.

The resin composition preferably contains an organic solvent in order to uniformly disperse the epoxy resin and the curing agent.

Examples of the organic solvent include polar organic solvents such as N-methyl-2-pyrrolidone, N,N-dimethylacetamide, N,N-dimethylformamide, dimethyl sulfoxide, tetramethylurea, hexaethylphosphoric triamide, and γ-butyrolactone; ketones such as acetone, methyl ethyl ketone, methyl isobutyl ketone, and cyclohexanone; esters such as methyl acetate, ethyl acetate, butyl acetate, and diethyl oxalate; ethers such as diethyl ether, ethylene glycol dimethyl ether, diethylene glycol monomethyl ether, ethylene glycol monobutyl ether (butyl cellosolve), diethylene glycol dimethyl ether, and tetrahydrofuran; hydrocarbon compounds such as hexane, heptane, benzene, toluene, and xylene; halogenated hydrocarbon compounds such as dichloromethane and chlorobenzene; phenols such as cresol and chlorophenol; and tertiary amines such as pyridine. These organic solvents may be used independently or in combination of two or more.

The content of the organic solvent is not particularly limited as long as it is an amount that can uniformly disperse the epoxy resin and the curing agent. However, it is generally preferable to determine the content of the organic solvent so that the solid content is about 25 to 50% from the viewpoint of uniformly dispersing the epoxy resin and the curing agent.

The resin composition may optionally contain additives within the range from which the objective of the present invention is not prevented. Examples of the additives include fillers such as silica, alumina, magnesium oxide, beryllium oxide, silicon carbide, titanium carbide, boron carbide, tungsten carbide, boron nitride, and silicon nitride; and, in order to improve the curability and fluidity of an insulating coating, titanium based compounds such as tetraisopropyl titanate, tetrabutyl titanate, and tetrahexyl titanate; zinc-based compounds such as zinc naphthenate and zinc octenate; antioxidants; curability improving agents; leveling agents; and adhesion aids. The resin composition may also be mixed with a resin other than the epoxy resin within the range not preventing the objective of the present invention.

The resin composition is prepared by uniformly mixing an epoxy resin, a curing agent, an organic solvent, an additive, and the like. The primer layer is formed by applying the resin composition to a conductor. The type of the conductor is not particularly limited. Examples of the conductor include a copper wire and an aluminum wire.

The method of applying the resin composition to the conductor is not particularly limited, but a conventional method such as dip coating may be used. After applying the resin composition to the conductor, the coating film of the resin composition is air dried or dried by heating at a temperature from ordinary temperature to about 300° C. In this way, the primer layer is formed.

It is preferable to bake the resin composition applied to the conductor from the viewpoint of sufficiently react the epoxy resin with the curing agent. The baking can be performed with a conventional method. The heating temperature for the baking is preferably from 200 to 300° C. from the viewpoint of sufficiently react the epoxy resin with the curing agent and from the viewpoint of preventing thermal degradation of the epoxy resin by high-temperature heating. When a blocked isocyanate is used as a curing agent, it is necessary to heat it to the dissociation temperature thereof or higher in order to dissociate the blocking agent to allow it to function as a curing agent. The number of times of the baking may be only once or may be two times or more. The thickness of the primer layer after drying is preferably from 0.5 to 5 μm, more preferably from 1 to 3 μm from the viewpoint of increasing adhesion between the insulating layer and the conductor.

Next, an insulating layer is formed on the primer layer formed on the conductor.

The type of the resin used for the insulating layer is not particularly limited. Specific examples of the resin forming the insulating layer include polyesterimide, polyamideimide, polyester, polyimide, polyvinyl chloride, polyethylene, polyamide, polyester, and polyurethane. The present invention is not limited to these examples.

From the viewpoint of increasing mechanical properties such as abrasion resistance, heat resistance, chemical resistance, oil resistance, and the like of the insulated wire, the insulating layer preferably comprises, as a main component, at least one resin selected from the group consisting of polyesterimide, polyamideimide, polyester, and polyimide, more preferably at least one resin selected from the group consisting of polyesterimide and polyamideimide. The “main component” means that the insulating layer consists only of a resin, or that the insulating layer contains a resin, which contains a different resin within the range which does not prevent the objective of the present invention.

Polyesterimide is obtained, for example, by allowing imidodicarboxylic acid, which is a reaction product of tricarboxylic anhydride and diamine, to react with a polyhydric alcohol.

Polyamideimide can be produced, for example, by a method of directly reacting tricarboxylic anhydride with a polyvalent isocyanate compound having two or more isocyanate groups in one molecule in an organic solvent. Polyesterimide can also be produced by a method of reacting tricarboxylic anhydride with a polyhydric amine compound having two or more amine groups in one molecule in a polar solvent to introduce an imide bonding and then amidating it with a polyvalent isocyanate compound having two or more isocyanate groups in one molecule. Specifically, polyamideimide can be easily produced by allowing trimellitic anhydride to react with diphenylmethane-4,4′-diisocyanate in a solvent such as N-methyl-2-pyrrolidone. The number average molecular weight of polyamideimide is preferably 10,000 or more from the viewpoint of increasing the toughness of the insulating layer. The number average molecular weight is a value determined by gel permeation chromatography, which is a value in terms of polystyrene.

Polyimide can be produced by using, for example, tetracarboxylic acid or its anhydride as an acid component and a diamine compound as an amine component, subjecting both components to polycondensation at a temperature of 0 to 100° C. under an anhydrous condition in a polar organic solvent, and dehydrating the resulting polyimide precursor to undergo ring closure.

The insulating layer is formed by, for example, applying a resin solution prepared by dissolving a resin in an organic solvent to a primer layer. The method of applying the resin solution to the primer layer is not particularly limited, but a conventional method such as dip coating may be used. After applying the resin to the primer layer, the insulating layer is air dried or dried by heating at a temperature from ordinary temperature to about 250° C. In this way, the insulating layer is formed. The insulating layer may be one layer or may be the same or different two layers.

The thickness of the insulating layer after drying is preferably 5 μm or more, more preferably 10 μm or more, further preferably 15 μm or more from the viewpoint of protecting the conductor, and preferably 100 μm or less, more preferably 80 μm or less, further preferably 50 μm or less from the viewpoint of increasing adhesion between the insulating layer and the primer layer.

In this way, the insulated wire is obtained by forming the primer layer on the conductor and coating the primer layer with the insulating layer.

The insulated wire of the present invention is excellent in adhesion between the conductor and the insulating layer not only at ordinary temperatures, but also in the case where the insulated wire is heated. Therefore, the insulated wire of the present invention can be suitably used in the field in which a coil comprising an insulated wire requires heat treatment, such as treatment with an impregnating varnish, in the field of producing self-bonding wires, and the like.

### EXAMPLES

Hereinafter, the present invention will be described in more detail based on Examples. However, the present invention is not limited to the following Examples.

### Production Example 1

A 1-L flask equipped with a thermometer, a cooling pipe, a calcium chloride packed tube, a stirrer, and a nitrogen blowing pipe was charged with 176.9 g of trimellitic anhydride, 1.95 g of trimellitic acid, and 233.2 g of methylene diisocyanate [trade name: Cosmonate PH, manufactured by Mitsui Takeda Chemical Industries Ltd.] while flowing nitrogen gas at a flow rate of 150 mL per minute from the nitrogen blowing pipe.

Next, to the flask was added 536 g of N-methyl-2-pyrrolidone as a solvent. The resulting mixture was kept heated at 80° C. for 3 hours with stirring, was then heated up to 120° C. in about 4 hours, and was kept heated at 120° C. for 3 hours. Then, the heating was stopped. To the flask were added 134 g of xylene to dilute the mixture, and the diluted mixture was allowed to cool to give a polyamideimide resin varnish having a nonvolatile content of 35% by weight (hereinafter referred to as general-purpose PAI).

### Production Example 2

The general-purpose PAI obtained in Production Example 1 in an amount of 100 parts by weight in terms of the solid content thereof was mixed with 1.5 parts by weight of polyethylene wax to give a polyamideimide resin varnish (hereinafter referred to as high lubricating PAI).

### Example 1

A bisphenol S phenoxy resin [a solution prepared by dissolving a phenoxy resin in cresol/cyclohexanone (solid content: 30% by weight), product name: YPS-007A-30A, manufactured by Tohto Kasei Co., Ltd.] was used as an epoxy resin. The bisphenol S phenoxy resin in an amount of 100 parts by weight in terms of the solid content thereof was mixed with 20 parts by weight of a melamine compound [trade name: Cymel 370, manufactured by Nihon Cytec Industries Inc.]. These components were mixed at room temperature until a uniform composition was obtained, thus obtaining a resin composition.

The resulting resin composition was applied to the surface of a copper conductor having a diameter of 0.999 mm and baked for several seconds in a baking oven set at 300 to 400° C. to form a primer layer. The thickness of the primer layer is shown in Table 1.

To the formed primer layer was applied the general-purpose PAI obtained in Production Example 1, which was baked for several seconds in a baking oven set at 300 to 400° C. to form an interlayer 1. The thickness of the interlayer 1 is shown in Table 1. To the formed interlayer 1 was applied the general-purpose PAI obtained in Production Example 2, which was baked for several seconds in a baking oven set at 300 to 400° C. to form an interlayer 2. The thickness of the interlayer 2 is shown in Table 1.

Next, to the formed interlayers consisting of two layers was applied the high lubricating PAI obtained in Product Example 2, which was baked for several seconds in a baking oven set at 300 to 400° C. to form a surface layer. The thickness of the surface layer is shown in Table 1.

As the physical properties of the resulting insulated wires, the adhesion at room temperature, average unidirectional abrasion, and adhesion after heating A to D, scratch shaving load, and softening resistance were evaluated based on the following methods. The results are shown in Table 1.

### (1) Adhesion at Room Temperature

According to JIS C3003 “8.1a) Quick Elongation”, film floating distance (the average when measuring at two places: average film floating distance) and the length of conductor exposure (the average when measuring at two places: average conductor exposure length) were examined at room temperature.

In detail, the obtained insulating wire was broken or elongated to a predetermined length, and the test piece after elongation was inspected at a predetermined magnification, thereby examining the length of the conductor which was exposed due to film cracking and the presence of film floating or the like. An apparatus capable of elongating an insulated wire at a tensile rate of about 4 m/s was used for this test.

### (2) Average Unidirectional Abrasion

Six samples were measured for unidirectional abrasion at room temperature according to JIS C3003 “9”. A load was first applied to a needle attached to a friction head, and the surface of the insulated wire on a test stand was rubbed using the needle of the friction head while continuously increasing the load. Next, the load at the time when the film was broken by the friction between the needle and the insulated wire to make electrical connection between the needle and the conductor was determined as a breaking load. Then, the average thereof was determined.

(3) Adhesion after Heating A

An insulated wire was heated for one hour in a thermostatic chamber at 200° C. and then removed from the thermostatic chamber to determine the average film floating distance and the average conductor exposure length in the same manner as in the above “(1) Adhesion at room temperature”.

(4) Adhesion after Heating B

An insulated wire was heated for one hour in a thermostatic chamber at 210° C. and then removed from the thermostatic chamber to determine the average film floating distance and the average conductor exposure length in the same manner as in the above “(1) Adhesion at room temperature”.

(5) Adhesion after Heating C

An insulated wire was heated for 6 hours in a thermostatic chamber at 160° C. and then removed from the thermostatic chamber to determine the average film floating distance and the average conductor exposure length in the same manner as in the above “(1) Adhesion at room temperature”.

(6) Adhesion after Heating D

An insulated wire was heated for 6 hours in a thermostatic chamber at 180° C. and then removed from the thermostatic chamber to determine the average film floating distance and the average conductor exposure length in the same manner as in the above “(1) Adhesion at room temperature”.

### (7) Scratch Shaving Load

An insulated wire was set perpendicularly to an Igetalloy wire having a diameter of 1.0 mm [manufactured by Sumitomo Electric Industries, Ltd.]. A horizontal load was applied to the insulated wire toward the Igetalloy wire. Then, the insulated wire was drawn and then subjected to a pinhole test [JIS C3003 “6C) Pinhole Method”]. The presence of a flaw which reaches the conductor was examined three times for every load, and the load at the limit where there was no appearance of a pinhole was defined as a scratch shaving load. In the pinhole test, a predetermined length of the insulated wire was first taken, immersed in a constant temperature bath, and heat-treated for 10 minutes. Then, the heat-treated insulated wire was immersed in a 0.2% saline solution in which a suitable amount of a 3% alcohol solution of phenolphthalein has been dropped. Subsequently, a direct voltage of 12V was applied for 1 minute by using the saline solution as a positive electrode and the conductor of the insulated wire as a negative electrode, and the number of pinholes developed by applying the voltage was counted.

### (7) Softening Resistance

Softening resistance was measured according to JIS C3003 “11.1A.” In the softening resistance test, two insulated wires were first prepared, and then the insulated wires were set by crossing these wires to each other on a metal block previously heated to a temperature stipulated in a separate standard. After a specified time lapse, a load was applied to the crossing portion of the insulated wires using a piston, and a test voltage was immediately applied to the insulated wires placed up and down to each other.

### Example 2

An insulated wire was produced in the same manner as in Example 1 except that a bisphenol A phenoxy resin [product name: YP-50, manufactured by Tohto Kasei Co., Ltd.] was used as an epoxy resin instead of the bisphenol S phenoxy resin in Example 1. The physical properties of the resulting insulated wire were examined in the same manner as in Example 1. The results are shown in Table 1.

### Example 3

An insulated wire was produced in the same manner as in Example 1 except that a bisphenol A phenoxy resin [product name: YP-50, manufactured by Tohto Kasei Co., Ltd.] was used as an epoxy resin instead of the bisphenol S phenoxy resin in Example 1; and a blocked isocyanate [trade name: MS-50, manufactured by Nippon Polyurethane Industry Co., Ltd.] was used instead of the melamine compound in Example 1. The physical properties of the resulting insulated wire were examined in the same manner as in Example 1. The results are shown in Table 1.

### Comparative Example 1

An insulated wire was produced in the same manner as in Example 1 except that a polyesterimide varnish [trade name: Isomid40SM-45, manufactured by Hitachi Chemical Co., Ltd.] was used instead of the resin composition in Example 1. The physical properties of the resulting insulated wire were examined in the same manner as in Example 1. The results are shown in Table 1.

### Comparative Example 2

An insulated wire was produced in the same manner as in Example 1 except that a high adhesion type polyesterimide varnish [trade name: EH402-45 No. 3, manufactured by Dainichiseika Color & Chemicals Mfg. Co., Ltd.] was used instead of the resin composition in Example 1. The physical properties of the resulting insulated wire were examined in the same manner as in Example 1. The results are shown in Table 1.

TABLE 1

| | | | Example/Comparative | | | | |
|---|---|---|---|---|---|---|---|
| | | | Example No. | | | | |
| | | | | | | Comparative | |
| | | | Example | | | Example | |
| | | | 1 | 2 | 3 | 1 | 2 |
| Thickness of primer layer | | | 3 | 3 | 3 | 3 | 3 |
| (μm) | | | | | | | |
| Thickness of interlayer 1 | | | 22 | 22 | 22 | 22 | 22 |
| (μm) | | | | | | | |
| Thickness of interlayer 2 | | | 5 | 5 | 5 | 5 | 5 |
| (μm) | | | | | | | |
| Thickness of surface layer | | | 2 | 2 | 2 | 2 | 2 |
| (μm) | | | | | | | |
| Physical properties | Adhesion | Average film | 0.5 | 0.5 | 0.5 | 3.6 | 0.5 |
| of insulated wires | at room | floating | | | | | |
| | temperature | distance (mm) | | | | | |
| | | Average | 0.5 | 0.5 | 0.5 | 0.5 | 0.5 |
| | | conductor | | | | | |
| | | exposure length | | | | | |
| | | (mm) | | | | | |
| | Average unidirectional | | 20.8 | 21.0 | 20.1 | 16.7 | 18.4 |
| | abrasion (N) | | | | | | |
| | Adhesion | Average film | 1.9 | 1.4 | 1.7 | 2.0 | 30.8 |
| | after | floating | | | | | |
| | heating A | distance (mm) | | | | | |
| | | Average | 0.5 | 0.5 | 0.5 | 0.6 | 3.6 |
| | | conductor | | | | | |
| | | exposure length | | | | | |
| | | (mm) | | | | | |
| | Adhesion | Average film | 1.6 | 1.4 | 1.3 | 7.8 | 33.8 |
| | after | floating | | | | | |
| | heating B | distance (mm) | | | | | |
| | | Average | 0.5 | 0.5 | 0.5 | 1.2 | 2.9 |
| | | conductor | | | | | |
| | | exposure length | | | | | |
| | | (mm) | | | | | |
| | Adhesion | Average film | 150.0 | 73.8 | 2.5 | 5.5 | 150.0 |
| | after | floating | | | | | |
| | heating C | distance (mm) | | | | | |
| | | Average | 150.0 | 55.1 | 0.2 | 1.0 | 150.0 |
| | | conductor | | | | | |
| | | exposure length | | | | | |
| | | (mm) | | | | | |
| | Adhesion | Average film | 150.0 | 150.0 | 2.9 | 14.1 | 150.0 |
| | after | floating | | | | | |
| | heating D | distance (mm) | | | | | |
| | | Average | 150.0 | 150.0 | 0.2 | 1.0 | 150.0 |
| | | conductor | | | | | |
| | | exposure length | | | | | |
| | | (mm) | | | | | |

| | | | | | |
|---|---|---|---|---|---|
| Scratch shaving load (×10³ N) | 78.4 | 78.4 | 73.5 | 58.8 | 68.6 |
| Softening resistance (° C.) | 370 | 392 | 392 | 403 | 417 |

The results from Table 1 show that the insulated wire obtained in each Example has comparable or better adhesion at room temperature and much better adhesion after heating A and B, as compared with the insulated wire obtained in each Comparative Example. This is because the insulated wire in each Example was produced using the resin composition of the present invention.

The results also show that the insulated wire obtained in each Example has larger scratch shaving load and better abrasion resistance (average unidirectional abrasion) and softening resistance than the insulated wire obtained in each Comparative Example. This is because the insulating layer is formed of polyamideimide or polyesterimide in each Example.

In particular, the results of the measurement of adhesion after heating C and D, where insulated wires were heated at 160 to 180° C. for 6 hours, show that the insulated wire in Example 3 had much better adhesion between the conductor and the insulating layer than the insulated wires obtained in each Comparative Example and other Examples. This is because an isocyanate (blocked isocyanate) was used as a curing agent for the insulating wire in Example 3.

Therefore, the insulated wire of the present invention has high mechanical strength and is excellent in adhesion between the conductor and the insulating layer not only at ordinary temperatures, but also in the case where the insulated wire is heated. For this reason, the insulated wire of the present invention can sufficiently respond to the reduction in size and increase in power of a motor. The insulated wire of the present invention can also be suitably used in the field in which a coil comprising an insulated wire requires heat treatment, such as treatment with an impregnating varnish, in the field of producing self-bonding wires, and the like.

The embodiments disclosed above are illustrative in all points and not limiting. The scope of the present invention is shown not by the above description but by the claims, and is intended to include all modifications within the equivalent meaning and scope of the claims.

1. An insulated wire comprising:
a conductor;
a primer layer coating the conductor; and
an insulating layer coating the primer layer,
wherein the primer layer is formed by curing an epoxy resin.

2. The insulated wire according to claim 1, wherein the primer layer comprises a resin composition comprising an epoxy resin and a curing agent, wherein the content of the curing agent is from 5 to 30 parts by weight with respect to 100 parts by weight of the epoxy resin.

3. The insulated wire according to claim 2, wherein the primer layer is formed by applying the resin composition to the conductor and baking the resin composition.

4. The insulated wire according to claim 2, wherein the curing agent is a melamine compound.

5. The insulated wire according to claim 2, wherein the curing agent is an isocyanate.

6. The insulated wire according to claim 1, wherein the insulating layer comprises, as a main component, at least one resin selected from the group consisting of polyesterimide, polyamideimide, polyester, and polyimide.

7. An electrical coil, wherein the coil is prepared by winding the insulated wire according to claim 1.

8. A motor, wherein the motor comprises an electrical coil according to claim 7.
